(19) United States
(12) Patent Application Publication
(10) Pub. No.: US 2026/0087157 A1
(43) Pub. Date: Mar. 26, 2026

(54) SECURE DATA TRANSFER TECHNIQUES

(71) Applicant: Apple Inc., Cupertino, CA (US)

(72) Inventors: Sinduja Murari, Santa Clara, CA (US); Skylar P. Peterson, Fremont, CA (US); Aaquib Mohammad, Santa Clara, CA (US); Athrey E. Nadhan, Chapel Hill, NC (US); Jennifer Song, San Francisco, CA (US); Richard W. Heard, San Francisco, CA (US); Yousuf H. Vaid, Fremont, CA (US)

(73) Assignee: Apple Inc., Cupertino, CA (US)

(21) Appl. No.: 18/895,141

(22) Filed: Sep. 24, 2024

(51) Int. Cl. G06F 21/60

(52) U.S. Cl. CPC G06F 21/606

(57) ABSTRACT

A computer-implemented method including receiving a first request to generate a machine-readable optical image associated with a user account for use in transferring data to the user account, transmitting a second request to validate the first request, receiving a determination that the second request meets a threshold score based at least in part on account data, generating the machine-readable optical image based at least in part on the determination, transmitting the machine-readable optical image, receiving a notification of a data transfer to the user account, generating an updated data log for the user account based at least in part on the data transfer, and disabling the machine-readable optical image based at least in part on the notification.

### BACKGROUND

The development and advancement of wireless communication has led to the utilization of wireless communication for performing many tasks. One such task for which wireless communication has been utilized is the performance of data transfer between accounts. However, there are security challenges in transferring data between accounts.

### BRIEF SUMMARY

One aspect of the disclosure provides for a computer-implemented method including receiving, by a service provider from an application of a user device, a first request to generate a machine-readable optical image associated with a user account for use in transferring data to the user account, where the user account is associated with the user device and the first request may include account data associated with the user account. The method also may include transmitting, by the service provider to a server, a second request to validate the first request, where the second request may include the account data. The method also may include receiving, by the service provider from the server, a determination that the second request meets a threshold score based at least in part on the account data. The method also may include generating, by the service provider, the machine-readable optical image based at least in part on the determination. The method also may include transmitting, by the service provider to the application of the user device, the machine-readable optical image. The method also may include receiving, by the service provider from an issuing device, a notification of a data transfer to the user account. The method also may include generating, by the service provider, an updated data log for the user account based at least in part on the data transfer. The method also may include disabling, by the service provider to the application of the user device, the machine-readable optical image based at least in part on the notification.

Implementations may include one or more of the following features. The account data may include at least one of geolocation data including past and current geographic data of the user device, or user information including at least one of security information or biometric information associated with the user account. The machine-readable optical image may include at least one of a barcode or a quick response code. The computer-implemented method further may include transmitting, by the service provider to an issuing device, an identifier request for a unique identifier associated with the machine-readable optical image based at least in part on the determination. Generating the machine-readable optical image may be based at least in part on the unique identifier. Receiving the unique identifier may include use conditions for the machine-readable optical image. The use conditions may include at least one of an expiration time period, a numerical use limit, or sharing limitations. The computer-implemented method further may include generating, by the server, the determination by generating a validation score based at least in part on the account data and comparing the validation score to the threshold score. Generating the validation score may be based at least in part on flagged user data of past suspicious behavior associated with the user account, or historical image usage data including at least one of a frequency of previous optical images that were used over a time period or a timestamp of a most recent use of an optical image. The data transfer request may include information of data seeking to be transferred to the user account. The computer-implemented method may further comprise updating, by the issuing device, the stored data log to incorporate the information.

One aspect of the disclosure provides for one or more non-transitory computer-readable media including computer-executable instructions that, when executed by one or more processors, cause the one or more processors to perform operations comprising receiving, by a service provider from an application of a user device, a first request to generate a machine-readable optical image associated with a user account for use in transferring data to the user account, where the user account is associated with the user device, and the first request may include account data associated with the user account. The operations also may include transmitting, by the service provider to a server, a second request to validate the first request, where the second request may include the account data. The operations also may include receiving, by the service provider from the server, a determination that the second request meets a threshold score based at least in part on the account data. The operations also may include generating, by the service provider, the machine-readable optical image based at least in part on the determination. The operations also may include transmitting, by the service provider to the application of the user device, the machine-readable optical image. The operations also may include receiving, by the service provider from an issuing device, a notification of a data transfer to the user account. The operations also may include generating, by the service provider, an updated data log for the user account based at least in part on the data transfer. The operations also may include disabling, by the service provider to the application of the user device, the machine-readable optical image based at least in part on the notification.

Implementations may include one or more of the following features. The account data may include at least one of geolocation data including past and current geographic data of the user device, or user information including at least one of security information or biometric information associated with the user account. The machine-readable optical image may include at least one of a barcode or a quick response code. The one or more non-transitory computer-readable media further may include transmitting, by the service provider to an issuing device, an identifier request for a unique identifier associated with the machine-readable optical image based at least in part on the determination. Generating the machine-readable optical image may be based at least in part on the unique identifier. Receiving the unique identifier may include use conditions for the machine-readable optical image. The use conditions may include at least one of an expiration time period, a numerical use limit, or sharing limitations.

One aspect of the disclosure provides for a system including a memory having computer-executable instructions. The system also may include a processor configured to access the memory and execute the computer-executable instructions to at receive, by a service provider from an application of a user device, a first request to generate a machine-readable optical image associated with a user account for use in transferring data to the user account, where the user account is associated with the user device, and the first request may include account data associated with the user account. The system also may transmit, by the service provider to a server, a second request to validate the first request, where the second request may include the account data. The system also may receive, by the service provider from the server, a determination that the second request meets a threshold score based at least in part on the account data. The system also may generate, by the service provider, the machine-readable optical image based at least in part on the determination. The system also may transmit, by the service provider to the application of the user device, the machine-readable optical image. The system also may receive, by the service provider from an issuing device, a notification of a data transfer to the user account. The system also may generate, by the service provider, an updated data log for the user account based at least in part on the data transfer. The system also may disable, by the service provider to the application of the user device, the machine-readable optical image based at least in part on the notification.

Implementations may include one or more of the following features. The system further may include transmitting, by the service provider to an issuing device, an identifier request for a unique identifier associated with the machine-readable optical image based at least in part on the determination and receiving, by the service provider from the issuing device, the unique identifier and use conditions associated with the unique identifier, where generating the machine-readable optical image is based at least in part on the unique identifier.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram showing an example document transfer environment, according to at least one example.

FIG. 2 illustrates a swim lane diagram showing example processes for generating an optical image, according to at least one example.

FIG. 3 illustrates a swim lane diagram showing example processes for transferring data, according to at least one example.

FIG. 4A illustrates an example user device displaying a button, according to at least one example.

FIG. 4B illustrates an example user device displaying an optical image, according to at least one example.

FIG. 4C illustrates an example user device displaying a disabled image, according to at least one example.

FIG. 5 illustrates an example flowchart for secure data transfer processes, according to at least one example.

FIG. 6 illustrates a simplified block diagram depicting an example architecture for implementing the techniques described herein, according to at least one example.

FIGS. 7A and 7B illustrate methods of application processes, in accordance with some embodiments.

FIG. 7C illustrates a device for implementing an API, in accordance with some embodiments.

FIG. 7D illustrates a system for implementing an API, in accordance with some embodiments.

FIGS. 7E and 7F illustrate data flows related to API processes, in accordance with some embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Examples of the present disclosure are directed to, among other things, methods, systems, devices, and computer-readable media that provide techniques for more securely transferring data using an optical image (e.g., a machine-readable optical image, such as a barcode, quick response codes, or the like) associated with a user account. For example, a user may decide to transfer data from a first user account to a second user account with a user device (e.g., a smart phone or other handheld and/or portable device) through a third-party device (e.g., a smart phone or other handheld and/or portable device). In particular, the third-party device may scan an optical image displayed on the user device to facilitate the data transfer between the first user account and the second user account. However, conventional methods of generating the optical image may provide inadequate security measures in verifying users and/or user accounts seeking to transfer data. The techniques described herein provide an improved method of generating the optical image with validation processes to verify a user and/or user accounts seeking to transfer data with the user account.

Specifically, a user may initiate the transfer process by interacting with an application installed on the user device that is configured to manage and present optical images (e.g., via a user interface (UI) or the like). The application may send a data transfer request to a service provider with account data associated with the user account. The service provider may send an image request to a server with the account data provided by the application. The server can validate whether the user account and/or user device is authorized to transfer data based at least in part on the account data. The server can transmit the validation determination to the service provider. If the validation determination is positive (e.g., the user account and/or the user device is authorized to transfer the data), the service provider can then request a unique identifier associated with the user account for use in the optical image from an issuing device that manages the data (e.g., stores, tracks, and updates the data) associated with the user account. The service provider may use the unique identifier to generate an optical image that is tied to the unique identifier such that the optical image is tied to the user account. The service provider may provide the optical image to the application. The application may display the optical image to the third-party device for the third-party device to scan. Once scanned, the third-party device can request the data to be transferred from the user device. The user device can provide data to the third-party device. Once the third-party device receives the data, the third-party device can provide, to the issuing device, information on the data seeking to be transferred by the user to the user device that data to the issuing device. The issuing device can update a stored log of data associated with the user account with the information provided by the third-party device.

The systems, devices, and techniques described herein provide several technical advantages that improve the security of transferring data. For example, validating that the user account and/or user device is authorized to transfer data can minimize the risk that an authorized user can transfer data, such as sensitive data.

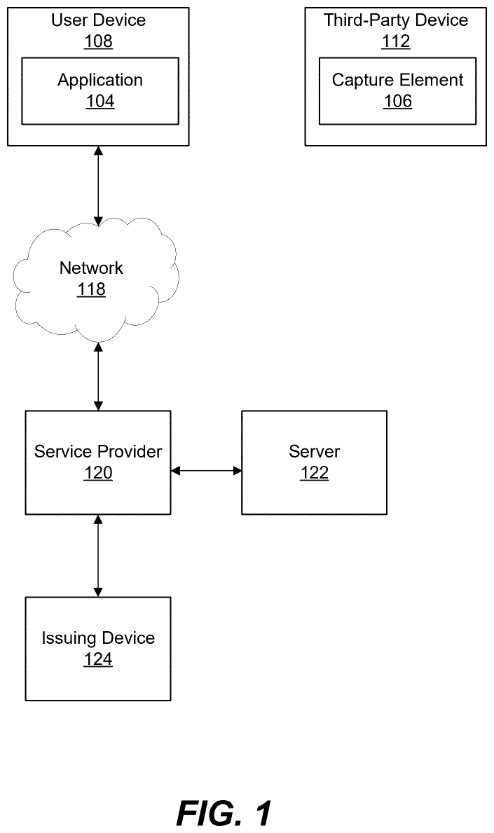

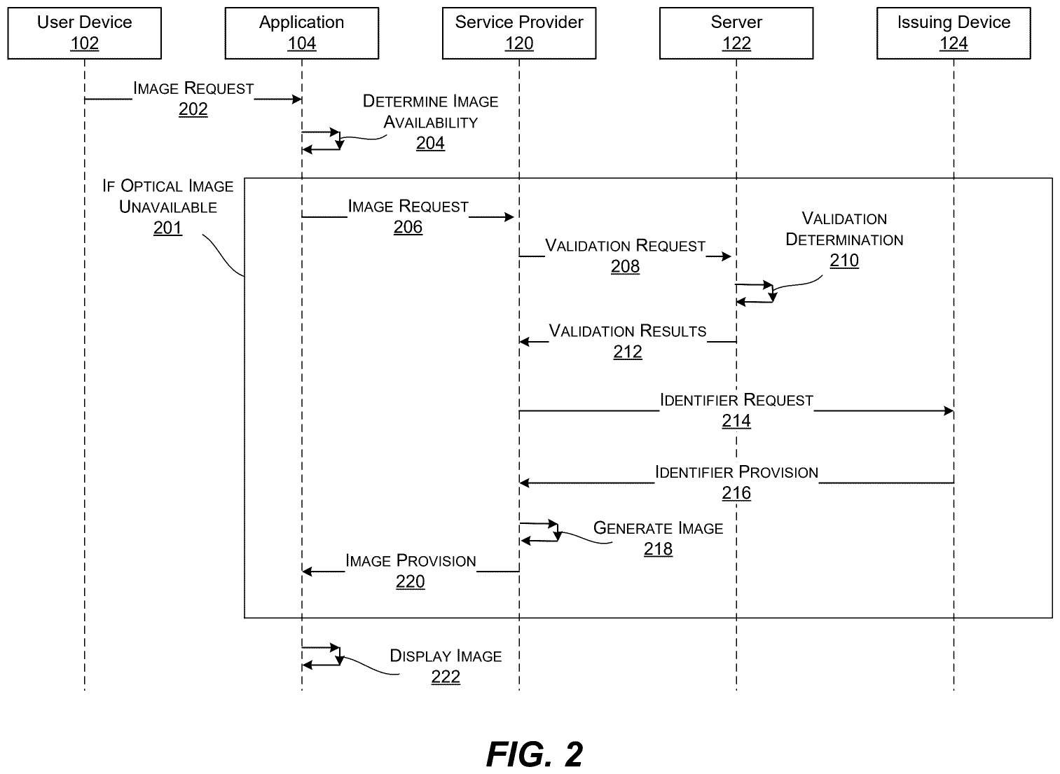

Turning now to the figures, FIG. 1 depicts a block diagram showing an example data transfer environment 100, according to at least one example. FIGS. 2-5 depict example flow diagrams showing data transfer processes using the data transfer environment 100, according to at least a few examples. The processes, and any other processes described herein. Each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The data transfer environment 100 may include a user device 102, such as a cellular phone, a tablet computing device, a laptop computer, a watch-based computing device, or the like. The user device 102 may be associated with one or more user accounts that includes a corresponding data associated with the user account. For example, user accounts may include a stored device identifier associated with the user device 102 (e.g., stored during creation of the user account). The user accounts may be associated with a storage of data (e.g., a balance of funds, such as cash, credit, gift card, or the like). The user device 102 may be able to perform a data transfer (e.g., transfer of funds) to or from the user account, as discussed below.

An application 104 may be installed in the user device 102 that manages and presents one or more optical images (e.g., a machine-readable optical image, such as a barcode, quick response codes, or the like). The optical images may be associated with the user account discussed above. A user may be able to select one of the optical images on the application 104 and the application 104 may display the optical image for scanning by another device to as a part of a data transfer process to the user account associated with the optical image.

The data transfer environment 100 may include a third-party device 112, such as a desktop computing device or server, a mobile device, (e.g., a cellular phone), a tablet computing device, a laptop computer, or the like. For example, the third-party device 112 may be an electronic device used by a merchant in a brick-and-mortar store, electronic marketplace, or the like. The third-party device 112 may include a capture element 106 that can scan the optical image displayed by the application 104 of the user device 102. For example, the capture device 114 may be a code scanner or camera that can scan and read information associated with the optical image (e.g., a unique digital identifier associated with a user account).

The user device 102 can communicate with a service provider 120 through a network 118 (e.g., the Internet, a wireless local area network, an Ethernet network, an intranet, an optical network, or other public or private network connection). The service provider 120 may be a network of one or more computing devices that can be directed to multiple purposes. For example, the service provider 120 can facilitate communications (e.g., data transfer requests or the like) between other devices. Additionally, the service provider 120 can generate the optical image and/or send instructions to disable the optical image once the optical image is scanned.

The service provider 120 may communicate with a server 122. Specifically, the server 122 may process validation requests seeking to validate whether the user account and/or user device 102 is authorized to transfer data. For example, as will be discussed further below, the server 122 may receive and analyze the account data associated with a user account of the user device 102 to determine whether the user account and/or the user device 102 is authorized to transfer data.

The service provider 120 may communicate with an issuing device 124. The issuing device 124 may store and manage data of various user accounts, including the user account associated with the user device 102. For example, the issuing device 124 may be a financial institution such as a bank, which may be an issuer of a credit card, gift cards, or other financial vehicle. This financial institution may store, manage, and update the funds that are associated with a user account (e.g., the amount of cash or gift card balance is on the user account).

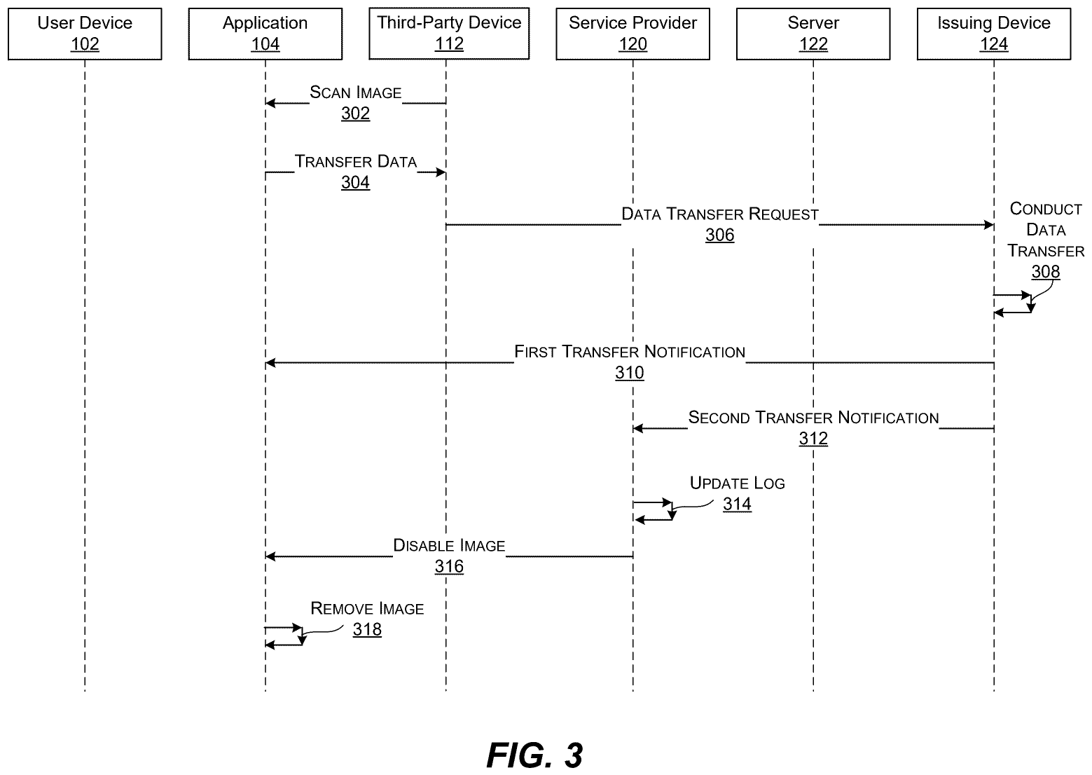

FIGS. 2 and 3 are swim lane diagrams illustrating a method for conducting a secure data transfer using the electronic devices of FIG. 1. In one example, a user may decide to transfer data (e.g., funds) to their user account that is associated with the user device 102 through the third-party device 112 (e.g., a merchant device in a brick-and-mortar store, such as a point-of-sale device). In particular, the user may generate an optical image in the application 104 for the capture element 106 of the third-party device 112 to scan and read. The optical image can be associated with the user account. FIG. 2 depicts the process of generating of this optical image.

At step 202, the user device 102 can transmit a first image request to the application 104 to generate an optical image associated with the user account. For example, the user may open the application 104 and provide an input (e.g., touch, click, or the like) to the user device 102 to select a user account in the application 104 and an option requesting to transfer data. Selecting this option may result in the user device 102 transmitting the first image request. During or before selecting the user account, the user may provide user information to the user device 102 to verify whether the user is an authorized user of the user account (e.g., when logging into the user account on the application 104). For example, the user may provide security information (e.g., a password, personal identification number, security questions, security tokens associated with the user device 102, or the like) and/or biometric information associated with the user (e.g., fingerprint recognition, facial recognition, iris scanning, voice recognition, or the like). In some examples, the user device 102 may also receive additional inputs related to how the user may want to transfer data or what type of data the user may want to transfer (e.g., cash, gift card balance, or the like).

At step 204, the application 104 may determine whether there is already an available optical image to use. For example, the application 104 may determine whether there are other optical images already stored. If there are stored optical images, the application 104 may then determine whether those stored optical images are valid. This may include determining whether the stored optical images are expired (e.g., the optical image was not scanned after a certain time period, after a certain date and time, or the like) or previously used (e.g., the optical image was already scanned by the other devices). If the optical image was previously used, the application 104 may determine where the optical image has a limited number of uses and whether the optical image has met the limited number of uses (e.g., where the optical image had a one-time use limitation and was already scanned by the third-party device 112). In some embodiments, the stored optical images (available, expired, or used) may be displayed in the application 104 on the user device 102 (e.g., on a UI of the user device 102). However, in other embodiments, the expired or used optical images may be internally stored in a memory without being displayed to the user.

If there is an available optical image for use, the application 104 may display the optical image for scanning. For example, the optical image may have been previously generated and the user did not yet have an opportunity to use the optical image. In this example, the data transfer process may move to step 302, as shown in FIG. 3, to continue with the data transfer process. However, if no optical image is available for use (e.g., there is no other stored optical image, or all optical images are expired or used), the data transfer process may continue with the steps of generating the optical image, as represented in box 201.

This step of determining whether there is already an available optical image to use can minimize the server load required to store and generate the optical images. For example, constantly generating and storing an available optical image ready for use can cause unnecessary data storage issues. Instead, the optical images can be generated and stored for use only when a user desires to use it (e.g., by transmitting a first image request at step 202) and when there is no available optical image for use. In this manner, computing resources and data storage can be saved.

At step 206, the application 104 may transmit a second image request to the service provider 120 to generate the optical image. The second image request may include account data associated with the user account and/or the user device 102. The account data may be data associated with the user account that is associated with the user device 102. As will be discussed later below, the account data may be used to validate whether the user account and/or the user device 102 is authorized to transfer data.

The account data may include geolocation data associated with a location the user device 102 (e.g., coordinates or other geographic location identifiers). As noted below, this information may be received based on informed consent by the user to provide this information. Such geographical data may include a current location of the user device 102 as well as past locations of the user device 102. The account data may also include user information, as noted above, used to later verify whether the user account is authorized to transfer data. The account data may include all of the geographical data and user information. However, in other embodiments, the account data may include less than all of the geographical data and user information (e.g., only one of the geographical data or user information).

At stop 208, the service provider 120 may transmit a validation request to the server 122 to validate the user account and/or user device 102. The validation request may include the account data. In particular, the validation request may request that the server 122 determine whether the user account and/or user device 102 is authorized to transfer data.

At step 210, the server 122 may determine whether the user account and/or the user device 102 is authorized to transfer data. For example, the server 122 may analyze the account data for fraudulent activity. This may include analyzing one or more of geographical data and/or user information in the account data, and/or other data available to the server 122 (e.g., flagged user data directed to whether the user account is suspicious, historical image use data, or the like), to determine a validation determination regarding whether the user account and/or user device 102 is authorized to transfer data. The server 122 may generate a score for each of these types of account data corresponding to a likelihood that the user account and/or user device 102 is authorized to transfer data (e.g., the likelihood of fraudulent activity associated with the image requests).

The server 122 may use the geographic data to compare the current location of the user device 102 with past locations of the user device 102. Specifically, the server 122 may determine how far the current location of the user device 102 is from past locations. The past locations that the server 122 compares the current location to may be a location where an optical image of the application 104 was last scanned (e.g., the most recent location that an optical image of the application 104 was last scanned). The past locations may also include a geographic grouping of locations within a certain threshold distance (e.g., a grouping of locations that can be associated with the user's home, place of work, or the like). The further away the current location of the user device 102 is from past locations, the higher the likelihood that the user device 102 is unauthorized to transfer data (e.g., the higher likelihood of fraudulent activity).

The server 122 may assign a geographic score corresponding to how far the current location of the user device 102 is from one or more past locations. For example, the server 122 may assign a higher score the further the current location of the user device 102 is from past locations as this can indicate a higher likelihood that the user device 102 is unauthorized to transfer data (e.g., fraudulent). The server 122 may additionally increase the geographic score if the current location of the user device 102 is in a location that the user device 102 has never been to. The server 122 may cap the geographic score once the distance is greater than a certain threshold as, once the distance is greater than that threshold, the likelihood that the image request is associated with unauthorized use (e.g., fraudulent behavior) as a result of the geographic distance may be maximized. For example, the geographic score may be capped once a distance between the current location and past locations is greater than about 100 miles, 500 miles, 1,000 miles, or the like.

The server 122 may analyze the user information to verify whether the user account is an authorized to transfer data. For example, the server 122 may compare the user information provided by the user when the user device 102 was verifying whether the user was an authorized user (e.g., security information and/or biometric information provided by the user when the user was logging into the user account) with the user information that the server 122 may have saved regarding the user account (e.g., security information and/or biometric information previously provided to the server 122, such as when the user first created the user account). The less amount of matches there are between the saved user information with the user information provided in the account data, the higher the likelihood that the user account is unauthorized to transfer data. The server 122 may assign a user score based on how much of the user information provided with the account data matches the stored user information. For example, the server 122 may assign a higher score corresponding to a lower number of matches as the lower number of matches may correspond to a higher likelihood that the user account is unauthorized to transfer data.

The server 122 may additionally analyze historical image usage data of prior usage of optical images to verify whether the user account is authorized to transfer data. The historical image use data may include the frequency, timing, and quantity of prior usage of optical images (e.g., how many times a user has scanned optical images to transfer data over a certain period of time and how recently this usage was). The historical image usage data may include the usage data of optical images on the user device 102 as well as other devices that the user account was logged into. The server 122 may store the historical image use data from prior image generation requests. Additionally or alternatively, the server 122 may receive the historical image used from the issuing device 124, the application 104, and/or the user device 102.

In one example, the server 122 may use the historical image use data to determine a number of times that previously-generated optical images associated with the user account were scanned to transfer data with the user account over a certain period of time (e.g., one minute, five minutes, one hour, one day, or the like), and when the last time a previously-generated optical image was scanned. The greater the number of times previously-generated optical images were previously scanned over that period of time, the greater the likelihood that the user account is not authorized to transfer data. Additionally, the more recently an optical image was previously scanned, the greater the likelihood that the user account is not authorized to transfer data. For example, a history of 10 previously-generated optical images having been scanned within a 5-minute time period, where the last optical image was scanned 3 minutes ago can indicate a greater likelihood of fraudulent activity as such behavior is unlikely to be performed by a typical user account. Accordingly, the server 122 may assign an image use score corresponding to the number of times previously-generated optical images were generated and scanned within a certain time period, and how recent a previously-generated optical image was scanned. The greater the number of times optical images were generated and scanned within that time period, and the more recent an optical image was scanned, the greater the image use score. In some embodiments, each of the above frequency of use and recency of use may be given a separate score and be separately weighted (e.g., a greater weight may be given to the frequency of use, such as 0.6, and a lesser weight may be given to the recency of use, such as 0.4, or the like).

The server 122 may consider flagged user data of past suspicious behavior associated with the user account. For example, the server 122 may consider past validation results. In one example, the greater the number of past negative validation results (e.g., past instances when the server 122 determined that the user account and/or user device 102 was not authorized to transfer data), the higher the likelihood that the user account and/or user device 102 is not authorized to transfer data. However, the greater the number of past positive validation results (e.g., instances when the server 122 determined that the user account and/or user device 102 was authorized to transfer data), the lower the likelihood that the user account and/or user device 102 is not authorized to transfer data. The server 122 may also consider the number of prior attempts to digitally transmit the optical image (e.g., screenshot or share the optical image), where the greater the number of prior attempts to digitally transmit the optical image, the higher the likelihood that the user account and/or user device 102 is not authorized to transfer data. The server 122 may generate a behavior score corresponding to the likelihood that the user account and/or user device 102 is not authorized to transfer data (e.g., the greater the likelihood of data transfer not being authorized, the greater the behavior score).

The server 122 may aggregate the geographic score, user score, image use score, and behavior score to generate a validation score. The server 122 may generate a validation determination by comparing the validation score to a threshold score to determine whether the user account and/or the user device 102 is authorized to transfer data. For example, the validation score may be a score between 0 and 100, and the threshold score may be 70. In this example, the validation determination may be negative where the validation score is determined to be 80 and the server 122 determines that the user account and/or the user device 102 is not authorized to transfer data, and that the first image request by the user device 102 should be denied. If the validation score is 50, the validation determination may be positive and the server 122 may determine that the user account and/or the user device 102 is authorized to transfer data, and that the service provider 120 should move forward with generating the optical image. The server 122 may store the date and time of each validation determination.

The server 122 may apply a weight to each of prior to aggregating the scores. The weight values may be determined by a trained machine learning model that is trained to identify unauthorized behavior associated with the user account and/or the user device 102. However, in other embodiments, less than each of the scores (e.g., none) may be weighted prior to being aggregated.

At step 212, the server 122 may send the validation determination to the service provider 120. In some embodiments, the server 122 may send, with the validation determination, each of the scores the server 122 used to generate the validation determination. However, in other embodiments, the server may only send the validation determination. If the validation determination is negative (e.g., a determination that the user account and/or the user device 102 is not authorized to transfer data), the service provider 120 may halt any further steps on generating the requested optical image and may transmit a rejection notification to the application 104 noting that the first image request is denied. In some embodiments, the rejection notification may indicate a reason corresponding to the scores used to determine the validation determination (e.g., if the image use score was the highest, the rejection notification may indicate that too many optical images have been generated and/or scanned too soon, or the like). If the validation determination is positive, the steps to generate the optical image may continue as shown in FIG. 2.

Performing such validation determination can minimize the risk that an unauthorized user account and/or user device 112 transfers data. For example, the server 122 can minimize the risk of funds being fraudulently transferred by bad actors misusing the user account and/or user device 112. However, in some embodiments, no validation request may be made to the server and the service provider may continue generating the optical image without determining whether the user account and/or user device is authorized to transfer data.

At step 214, the service provider 120 can transmit an identifier request to the issuing device 124 requesting a unique identifier associated with the user account for use in generating an optical image. For example, the identifier request may request a code, set of alphanumeric numbers, or the like associated with the user account that may be incorporated into an optical image such that, when the optical image is scanned, the scanning device (e.g., the third-party device 112) may identify the user account for data transfer. Further, the unique identifier may be associated with the data stored by the user account (e.g., the balance of funds in the user account) The issuing device 124 may generate a unique identifier that is associated with the user account. However, in other embodiments, the issuing device does not generate the unique identifier but, instead, flags a stored unique identifier previously associated with the user account for later transmission.

At step 216, the issuing device 124 may transmit the unique identifier to the service provider 120. The issuing device 124 may additionally transmit, with the unique identifier, use conditions setting limits on the use of the optical image, as noted below. However, in other embodiments, the issuing device may not transmit use conditions with the unique identifiers.

For example, one use condition may include expiration time period that determines how long the optical image may be valid for (e.g., how long the optical image can be validly used for, such as 15 minutes, 1 hour, 5 days, or the like). The application 104 may determine when the expiration conditions are met. Specifically, the application 104 may capture a timestamp corresponding to the initial display and/or provision of the optical image in the application 104. If the optical image is not scanned within the expiration time period, the application 104 may disable the optical image such that the optical image may not be scanned to transfer data. In some embodiments, trying to scan the disabled image may result in an error message on one or more of the scanning device or user device 102. In some embodiments, the disabled optical image can change color and/or opacity to indicate that the optical image is disabled. In other embodiments, the disabled optical image may be removed from the application 104.

Another use condition may include a numerical use limit for the optical image. For example, the optical image may be a single-use optical image that may be utilized for a single data transfer. After the optical image has been used and meets the numerical use limit, the application 104 may disable the optical image to prevent the optical image from scanned again. In some embodiments, the service provider 120 may verify that the optical image has only been utilized for a single data transfer before starting a later data transfer with the optical image. In this example, the service provider 120 may prevent any further data transfers with the optical image as the optical image has already been utilized. However, in other embodiments, the numerical limit can be more than one use, such as two, three, four or the like.

The use condition may include a sharing limitation that can prevent the user device 102 from digitally capturing (e.g., taking screenshots, screen recording, screensharing, or the like) the optical image while the optical image is displayed. In other examples, the sharing limitation may allow the user device 102 to digitally capture the UI of the user device 102 while the optical image is being displayed, however, the digital capture may be prevented from capturing the optical image itself.

At step 218, the service provider 120 can generate an optical image. For example, the service provider 120 may encode the unique identifier and use conditions, if any, into an encoded pattern (e.g., a sequence of bars, spaces, or the like). The service provider 120 then converts this encoded pattern into a visual image to form the optical image.

At step 220, the service provider 120 can transmit the optical image to the application 104.

At step 222, the application 104 may display the optical image. In particular, the application 104 can display the optical image on a UI of the user device 102. The optical image can be displayed in a variety of settings, such as when the phone includes a darker color scheme (e.g., by reversing the black and white colors on the optical image against the darker background of the UI when is in the darker color scheme), increasing the brightness of the UI, and adjusting a size and shape of the optical image to account for smaller phones. In some embodiments, where the user of the third-party device 112 has certain sight disabilities, the user device 102 may audibly read out the unique identifier of the optical image.

FIG. 3 depicts the process of transferring data once the optical image is generated using the electronic devices of FIG. 1. At step 302, the third-party device 112 scans the optical image. For example, the capture element 106 can scan the optical image on the application 104 to read the unique identifier associated with the optical image and identify the user account to facilitate the data transfer with.

At step 304, the application 104 may transfer data to the third-party device 112. In particular, the user may seek to transfer data to the user account. In one example, the user may provide funds (e.g., cash, credit, debit, gift cards, or any other form of payment) to the third-party device 112 to add to the balance of the user account, such as increasing a gift card balance on the user account.

At step 306, the third-party device 112 may transmit a data transfer request to the issuing device 124 to request the issuing device 124 update a log of the data in the user account. The data transfer request can include information of the data seeking to be transferred by the user and/or the application 104 to the third-party device 112. For example, the data transfer request can include the numerical value of the amount of funds the user and/or the application 104 provided to the third-party device 112.

At step 308, the issuing device 124 may conduct the data transfer to the user account. For example, the issuing device 124 may transfer data to the user account based on the information of data seeking to be transferred by the user and/or the application 104 to the third-party device 112. In one example, the issuing device 124 may update a ledger of funds indicating the balance on the user account with the numerical value of the amount of funds the user and/or the application 104 provided to the third-party device 112. The issuing device 124 may performing a validation determination that the user account is authorized to transfer data prior to transferring the data to the user account (e.g., similar to the to the validation determination performed by the server 122 at step 210, shown in FIG. 2). If the validation determination is negative, the issuing device 124 may reject the data transfer request. If the validation determination is positive, the issuing device 124 may transfer data to the user account as noted above.

At step 310, the issuing device 124 can transmit a first transfer notification to the third-party device 112 noting that the data transfer is completed. The third-party device 112 can update internal records noting that the transfer is completed. The user of the third-party device 112 can also notify the user of the user device 102 that the transfer is completed. However, in other embodiments, the issuing device may not transmit the first transfer notification to the third-party device.

At step 312, the issuing device 124 can also transmit a second transfer notification to the service provider 120 noting that the data transfer is completed.

At step 314, the service provider 120 may generate an updated log for the user account. For example, the service provider 120 can update a log associated with the data of the user account associated with the optical image. This can include updating a log or ledger of the data that was transferred for the user account (e.g., the amount of funds transferred to the user account by the issuing device 124).

At step 316, the service provider 120 may disable the optical image. In particular, the service provider 120 can send instructions to the application 104 to disable the optical image (e.g., by sending instructions to label the optical image as having been used). The service provider 120 may send the instructions only after the service provider 120 receives the second transfer notification.

At step 318, the application 104 may remove the optical image from the application 104 from display as an available optical image. For example, the application 104 may disable the optical image by labelling the optical image as being used. As noted above, disabling the optical image as being used can prevent the optical image from being used again (e.g., to transfer more data with). In other embodiments, the application may remove the optical image from display completely.

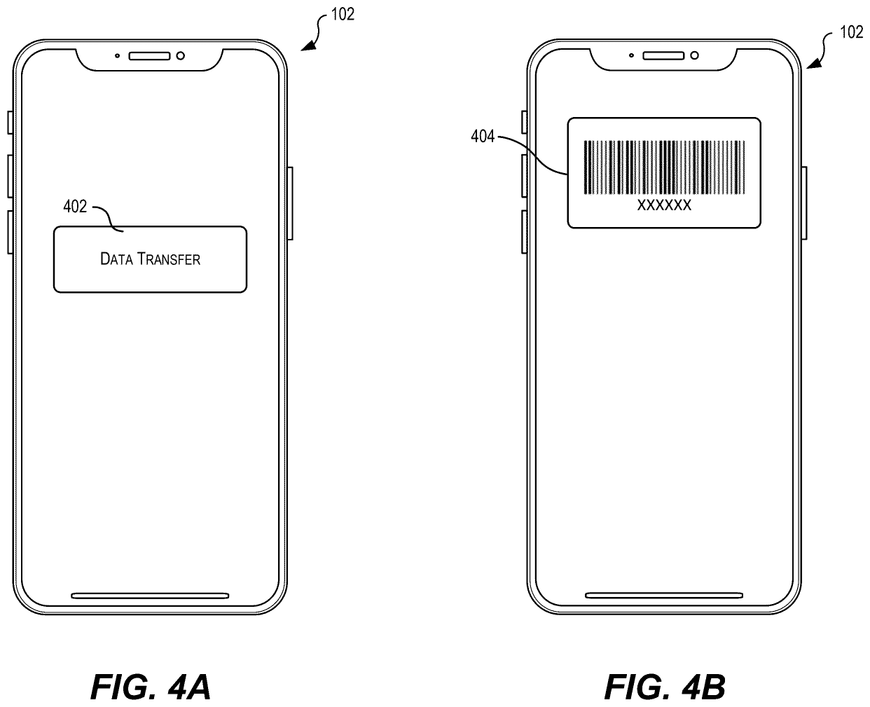

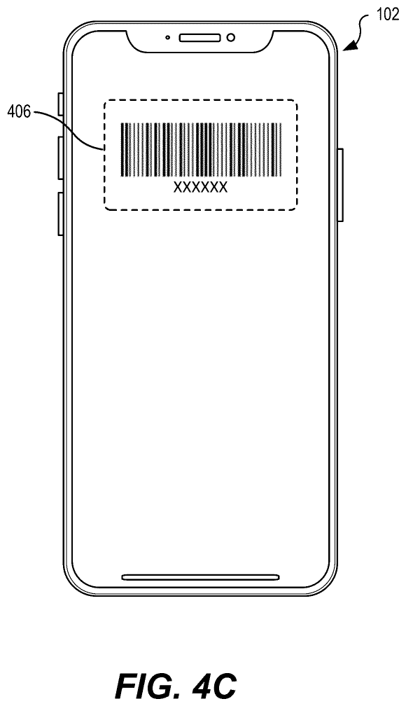

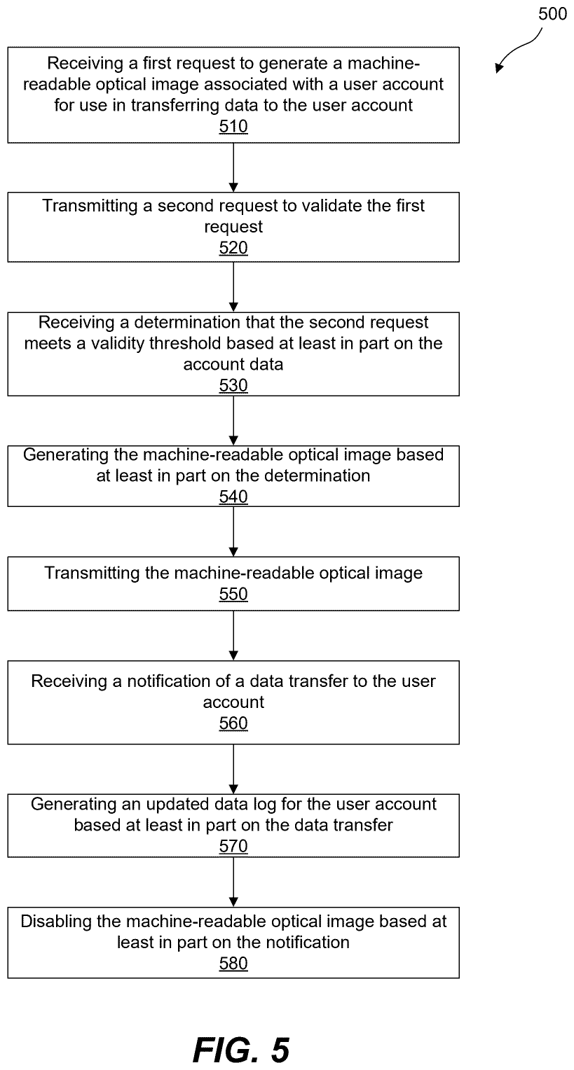

FIGS. 4A-4C depict the secure data transfer process displayed on the user device 102. For example, FIG. 4A depicts the user device 102 displaying a button 402 that is associated with initiation the data transfer process noted above. The button can be displayed on the application 104 of the user device 102. The user may decide to transfer data and interact with the button 402 to initiate the data transfer process. In particular, selecting the button 402 may initiate the process of transmitting an image request to the application 104 at step 202, as shown in FIG. 2, to generate an optical image.

FIG. 4B depicts the user device 102 displaying an optical image 404. The optical image 404 may correspond to the optical image generated by the service provider 120 at step 218 and transmitted at step 220, as shown in FIG. 2. As shown, the optical image 404 is a machine-readable optical image including a barcode that can be scanned and read by other devices. The optical image 404 can include the unique identifier visibly displayed, as shown in placeholder format “XXXXXX” in FIG. 4B below the barcode. The optical image 404 can be shown and displayed on the application 104 of the user device 102. The optical image 404 can be shown to the third-party device 112 so that the third-party device 112 can scan the optical image 404 to initiate the data transfer process with the third-party device 112 at step 302, as shown in FIG. 3. In other embodiments, the optical image may be part of a list of other displayed optical images (e.g., used or expired optical images).

FIG. 4B depicts the user device 102 displaying a disabled image 406. The disabled image 406 may correspond to the optical image 404 after the optical image 404 has been scanned. For example, the application 104 may have received instructions from the service provider 120 to remove the optical image 404 from the list of available displayed optical images to display the disabled image 406 instead. The disabled image 406 can have a different color and/or opacity from the optical image 404 to indicate that the optical image 404 is disabled. In other embodiments, the disabled optical image may have other indications that the image is disabled, such as a text noting that the image is disabled. In yet other embodiments, there may be no disabled image and the application may remove the optical image from display after receiving the instructions to disable the image.

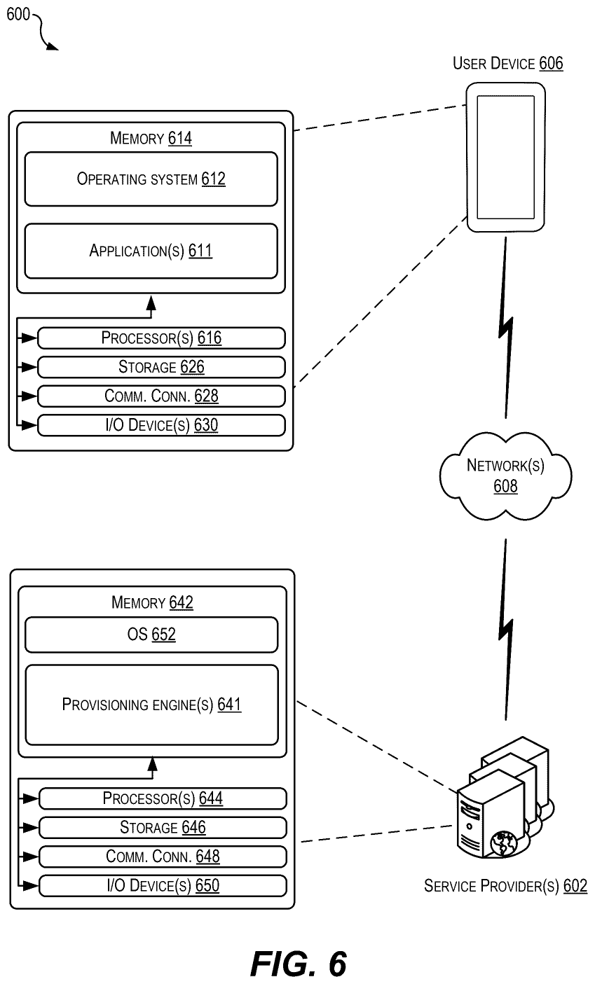

FIG. 5 depicts an example flowchart showing a process 500 for secure data transfer. Unless noted otherwise, the process 500 will be performed by the service provider 120. For example, a user may initiate the process by, with reference to FIG. 4A, selecting the button 402 to send an image request to the service provider 120.

At block 510, the service provider 120 can receive a first image request to generate a machine-readable optical image associated with a user account for use in transferring data to the user account. For example, the service provider 120 can receive a first image request from the application 104 of the user device 102 to generate an optical image (e.g., the optical image 404, as shown in FIG. 4B). The application 104 may send account data (e.g., geolocation data, user information, or the like, as discussed above in FIG. 2) with the first image request. The account data may be associated with the user account of the user and/or the user device 102.

At block 520, the service provider 120 can transmit a second request to validate the first request. For example, the service provider 120 can transmit a validation request to the server 122 to validate that the user account and/or the user device 102 is authorized to transfer data. The validation request may include the account data the service provider 120 received from the application 104. The server 122 may analyze the account data as well as other data (e.g., flagged user data of past suspicious behavior associated with the user account, historical image use data, or the like) to determine whether the user account and/or the user device 102 is authorized to transfer data. Based at least in part on this account data and/or flagged user data, the server 122 may generate a positive validation determination (e.g., where the validation score is greater than a threshold score, and the user account and/or the user device 102 is authorized to transfer data) or negative validation determination (e.g., where the validation score is less than a threshold score, and the user account and/or the user device 102 is not authorized to transfer data).

At block 530, the service provider 120 may receive a determination that the second request meets a validity threshold based at least in part on the account data. For example, the service provider 120 may receive a positive determination because the validation score associated with the first image request is greater than a threshold score. However, if the determination is negative, the service provider 120 may end the data transfer process and transmit a notification to the application 104 that the optical image cannot be generated.

At block 540, the service provider 120 may generate the machine-readable optical image based at least in part on the determination. For example, once the service provider 120 receives the positive determination, the service provider 120 may transmit an identifier request to the issuing device 124 requesting a unique identifier associated with the user account for use in generating an optical image. The issuing device 124 can subsequently transmit a unique identifier associated with the user account to the service provider. The issuing device 124 may include use conditions for the optical image generated with the unique identifier, such as an expiration time period, a numerical use limit, sharing limitations, or the like. The service provider 120 may use that unique identifier to generate the optical image.

At block 550, the service provider 120 may transmitting the machine-readable optical image. For example, the service provider 120 may transmit the optical image to the application 104 for display, as shown with the optical image 440 in FIG. 4B. The user may show the optical image 440 to the third-party device 112 to scan (e.g., with the capture element 106) and read to initiate the data transfer process as described in FIG. 3.

At block 560, the service provider 120 can receive a notification of a data transfer to the user account. For example, the service provider 120 may receive the second transfer notification from the issuing device 124 noting that the data transfer is completed, as shown in step 312 in FIG. 3.

At block 570, the service provider 120 may generate an updated data log for the user account based at least in part on the data transfer. For example, the service provider 120 may updated a log associated with the data of the user account that associated with the optical image, such as by updating a log or ledger of the data that was transferred for the user account.

At block 580, the service provider 120 may disable the machine-readable optical image based at least in part on the notification. For example, the service provider 120 may send instructions to the application 104 to disable the optical image (e.g., sending instructions to label the optical image as having been used). The application 104 can then remove the optical image from the application 104 from display as an available optical image, as shown by the disabled image 406 in FIG. 4C.

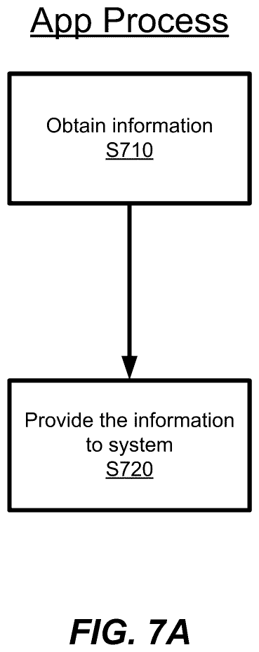

FIG. 6 illustrates an example architecture or environment 600 configured to implement techniques described herein, according to at least one example. In some examples, the example architecture or environment 600 may further be configured to enable a user device 606 and service provider computer 602 to share information. The service provider computer 602 is an example of the service provide 120. The user device 606 is an example of the user device 102. In some examples, the devices may be connected via one or more networks 608 (e.g., via Bluetooth, WiFi, the Internet, or the like). In some examples, the service provider computer 602 may be configured to implement at least some of the techniques described herein with reference to the user device 606.

In some examples, the networks 608 may include any one or a combination of many different types of networks, such as cable networks, the Internet, wireless networks, cellular networks, satellite networks, other private and/or public networks, or any combination thereof.

While the illustrated example represents the user device 606 accessing the service provider computer 602 via the networks 608, the described techniques may equally apply in instances where the user device 606 interacts with the service provider computer 602 over a landline phone, via a kiosk, or in any other manner. It is also noted that the described techniques may apply in other client/server arrangements (e.g., set-top boxes, etc.), as well as in non-client/server arrangements (e.g., locally stored applications, peer-to-peer configurations, etc.).

As noted above, the user device 606 may be any type of computing device such as, but not limited to, a mobile phone, a smartphone, a personal digital assistant (PDA), a laptop computer, a desktop computer, a thin-client device, a tablet computer, a wearable device such as a smart watch, or the like. In some examples, the user device 606 may be in communication with the service provider computer 602 via the network 608, or via other network connections.

In one illustrative configuration, the user device 606 may include at least one memory 614 and one or more processing units (or processor(s)) 616. The processor(s) 616 may be implemented as appropriate in hardware, computer-executable instructions, firmware, or combinations thereof. Computer-executable instruction or firmware implementations of the processor(s) 616 may include computer-executable or machine-executable instructions written in any suitable programming language to perform the various functions described. The user device 606 may also include geo-location devices (e.g., a global positioning system (GPS) device or the like) for providing and/or recording geographic location information associated with the user device 606.

The memory 614 may store program instructions that are loadable and executable on the processor(s) 616, as well as data generated during the execution of these programs. Depending on the configuration and type of the user device 606, the memory 614 may be volatile (such as random access memory (RAM)) and/or non-volatile (such as read-only memory (ROM), flash memory, etc.). The user device 606 may also include additional removable storage and/or non-removable storage 626 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 614 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 614 and the additional storage 626, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. The memory 614 and the additional storage 626 are both examples of non-transitory computer storage media. Additional types of computer storage media that may be present in the user device 606 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 606. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 606 may also contain communications connection(s) 628 that allow the user device 606 to communicate with a data store, another computing device or server, user terminals, and/or other devices via the network 608. The user device 606 may also include I/O device(s) 630, such as a keyboard, a mouse, a pen, a voice input device, a touch screen input device, a display, speakers, a printer, etc.

Turning to the contents of the memory 614 in more detail, the memory 614 may include an operating system 612 and/or one or more application programs or services for implementing the features disclosed herein such as applications 611 (e.g., digital wallet, third-party applications, browser application, etc.). In some examples, the service provider computer 602 may also include a health application to perform similar techniques as described with reference to the user device 606. Similarly, at least some techniques described with reference to the service provider computer 602 may be performed by the user device 606.

The service provider computer 602 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, a virtual machine instance, etc. In some examples, the service provider computer 602 may be in communication with the user device 606 via the network 608, or via other network connections.

In one illustrative configuration, the service provider computer 602 may include at least one memory 642 and one or more processing units (or processor(s)) 644. The processor(s) 644 may be implemented as appropriate in hardware, computer-executable instructions, firmware, or combinations thereof. Computer-executable instruction or firmware implementations of the processor(s) 644 may include computer-executable or machine-executable instructions written in any suitable programming language to perform the various functions described.

The memory 642 may store program instructions that are loadable and executable on the processor(s) 644, as well as data generated during the execution of these programs. Depending on the configuration and type of service provider computer 602, the memory 642 may be volatile (such as RAM) and/or non-volatile (such as ROM, flash memory, etc.). The service provider computer 602 may also include additional removable storage and/or non-removable storage 646 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 642 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 642 and the additional storage 646, both removable and non-removable, are both additional examples of non-transitory computer-readable storage media.

The service provider computer 602 may also contain communications connection(s) 648 that allow the service provider computer 602 to communicate with a data store, another computing device or server, user terminals and/or other devices via the network 608. The service provider computer 602 may also include I/O device(s) 650, such as a keyboard, a mouse, a pen, a voice input device, a touch input device, a display, speakers, a printer, etc.

Turning to the contents of the memory 642 in more detail, the memory 642 may include an operating system 652 and/or one or more application programs or services for implementing the features disclosed herein including a provisioning engine(s) 641.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

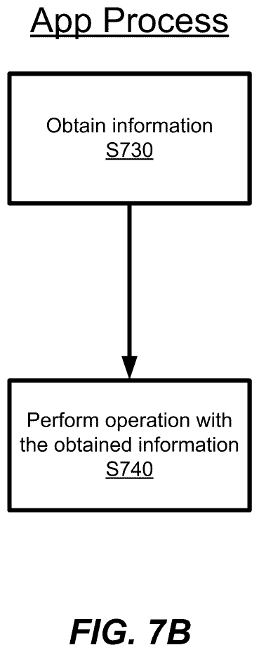

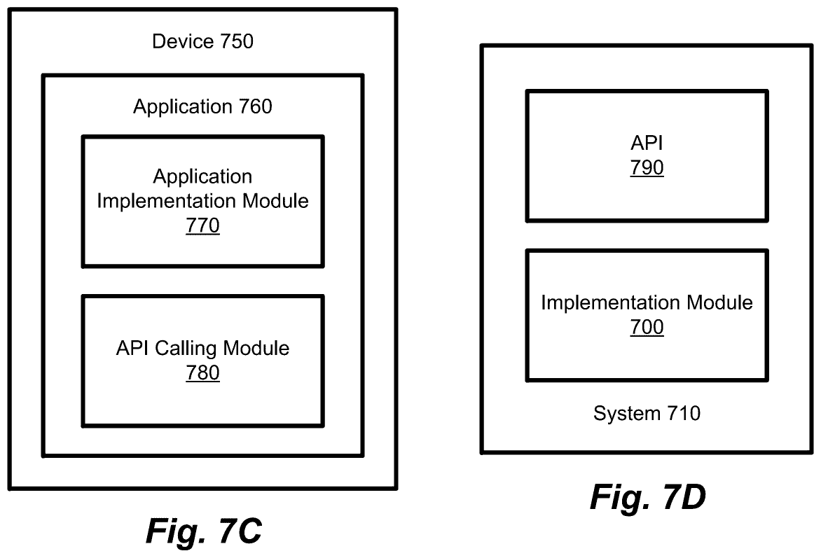

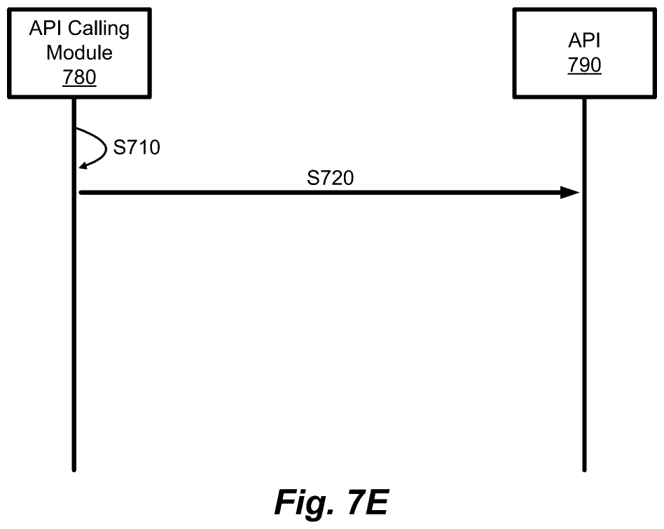

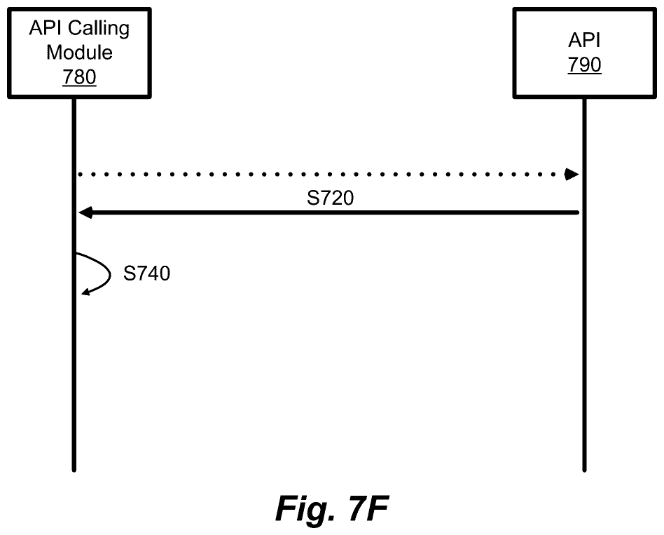

Implementations within the scope of the present disclosure include a computer-readable storage medium that encodes instructions organized as an application (e.g., application 760) that, when executed by one or more processing units, control an electronic device (e.g., device 750) to perform the method of FIG. 7B, the method of FIG. 7C, and/or one or more other processes and/or methods described herein.

It should be recognized that application 760 (shown in FG. 7D) can be any suitable type of application, including, for example, one or more of: an accessory companion application, a browser application, an application that functions as an execution environment for plug-ins, widgets or other applications, a fitness application, a health application, a digital payments application, a media application, a social network application, a messaging application, and/or a maps application. In some embodiments, application 760 is an application that is pre-installed on device 750 at purchase (e.g., a first party application). In other embodiments, application 760 is an application that is provided to device 750 via an operating system update file (e.g., a first party application or a second party application). In other embodiments, application 760 is an application that is provided via an application store. In some embodiments, the application store can be an application store that is pre-installed on device 750 at purchase (e.g., a first party application store). In other embodiments, the application store is a third-party application store (e.g., an application store that is provided by another application store, downloaded via a network, and/or read from a storage device).

Referring to FIG. 7B and FIG. 7F, application 760 obtains information (e.g., S710). In some embodiments, at S710, information is obtained from at least one hardware component of the device 750. In some embodiments, at S710, information is obtained from at least one software module of the device 750. In some embodiments, at S710, information is obtained from at least one hardware component external to the device 750 (e.g., a peripheral device, an accessory device, a server, etc.). In some embodiments, the information obtained at S710 includes positional information, time information, notification information, user information, environment information, electronic device state information, weather information, media information, historical information, event information, hardware information, and/or motion information. In some embodiments, in response to and/or after obtaining the information at S710, application 760 provides the information to a system (e.g., S720).

In some embodiments, the system (e.g., 710 shown in FIG. 7E) is an operating system hosted on the device 750. In some embodiments, the system (e.g., 710 shown in FIG. 7E) is an external device (e.g., a server, a peripheral device, an accessory, a personal computing device, etc.) that includes an operating system.

Referring to FIG. 7C and FIG. 7G, application 760 obtains information (e.g., S730). In some embodiments, the information obtained at S730 includes positional information, time information, notification information, user information, environment information electronic device state information, weather information, media information, historical information, event information, hardware information and/or motion information. In response to and/or after obtaining the information at S730, application 760 performs an operation with the information (e.g., S740). In some embodiments, the operation performed at S740 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 710 based on the information.

In some embodiments, one or more steps of the method of FIG. 7B and/or the method of FIG. 7C is performed in response to a trigger. In some embodiments, the trigger includes detection of an event, a notification received from system 710, a user input, and/or a response to a call to an API provided by system 710.

In some embodiments, the instructions of application 760, when executed, control device 750 to perform the method of FIG. 7B and/or the method of FIG. 7C by calling an application programming interface (API) (e.g., API 790) provided by system 710. In some embodiments, application 760 performs at least a portion of the method of FIG. 7B and/or the method of FIG. 7C without calling API 790.

In some embodiments, one or more steps of the method of FIG. 7B and/or the method of FIG. 7C includes calling an API (e.g., API 790) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 7D, device 750 is illustrated. In some embodiments, device 750 is a personal computing device, a smart phone, a smart watch, a fitness tracker, a head mounted display (HMD) device, a media device, a communal device, a speaker, a television, and/or a tablet. As illustrated in FIG. 7D, device 750 includes application 760 and operating system (e.g., system 710 shown in FIG. 7E). Application 760 includes application implementation module 770 and API calling module 780. System 710 includes API 790 and implementation module 700. It should be recognized that device 750, application 760, and/or system 710 can include more, fewer, and/or different components than illustrated in FIGS. 7D and 7E.

In some embodiments, application implementation module 770 includes a set of one or more instructions corresponding to one or more operations performed by application 760. For example, when application 760 is a messaging application, application implementation module 770 can include operations to receive and send messages. In some embodiments, application implementation module 770 communicates with API calling module to communicate with system 710 via API 790 (shown in FIG. 7E).

In some embodiments, API 790 is a software module (e.g., a collection of computer-readable instructions) that provides an interface that allows a different module (e.g., API calling module 780) to access and/or use one or more functions, methods, procedures, data structures, classes, and/or other services provided by implementation module 700 of system 710. For example, API-calling module 780 can access a feature of implementation module 700 through one or more API calls or invocations (e.g., embodied by a function or a method call) exposed by API 790 and can pass data and/or control information using one or more parameters via the API calls or invocations. In some embodiments, API 790 allows application 760 to use a service provided by a Software Development Kit (SDK) library. In other embodiments, application 760 incorporates a call to a function or method provided by the SDK library and provided by API 790 or uses data types or objects defined in the SDK library and provided by API 790. In some embodiments, API-calling module 780 makes an API call via API 790 to access and use a feature of implementation module 700 that is specified by API 790. In such embodiments, implementation module 700 can return a value via API 790 to API-calling module 780 in response to the API call. The value can report to application 760 the capabilities or state of a hardware component of device 750, including those related to aspects such as input capabilities and state, output capabilities and state, processing capability, power state, storage capacity and state, and/or communications capability. In some embodiments, API 790 is implemented in part by firmware, microcode, or other low level logic that executes in part on the hardware component.

In some embodiments, API 790 allows a developer of API-calling module 780 (which can be a third-party developer) to leverage a feature provided by implementation module 700. In such embodiments, there can be one or more API-calling modules (e.g., including API-calling module 780) that communicate with implementation module 700. In some embodiments, API 790 allows multiple API-calling modules written in different programming languages to communicate with implementation module 700 (e.g., API 790 can include features for translating calls and returns between implementation module 700 and API-calling module 780) while API 790 is implemented in terms of a specific programming language. In some embodiments, API-calling module 780 calls APIs from different providers such as a set of APIs from an OS provider, another set of APIs from a plug-in provider, and/or another set of APIs from another provider (e.g., the provider of a software library) or creator of the another set of APIs.

Examples of API 790 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 750. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 700 is a system (e.g., operating system, server system) software module (e.g., a collection of computer-readable instructions) that is constructed to perform an operation in response to receiving an API call via API 790. In some embodiments, implementation module 700 is constructed to provide an API response (via API 790) as a result of processing an API call. By way of example, implementation module 700 and API-calling module 180 can each be any one of an operating system, a library, a device driver, an API, an application program, or other module. It should be understood that implementation module 700 and API-calling module 780 can be the same or different type of module from each other. In some embodiments, implementation module 700 is embodied at least in part in firmware, microcode, or other hardware logic.

In some embodiments, implementation module 700 returns a value through API 790 in response to an API call from API-calling module 780. While API 790 defines the syntax and result of an API call (e.g., how to invoke the API call and what the API call does), API 790 might not reveal how implementation module 700 accomplishes the function specified by the API call. Various API calls are transferred via the one or more application programming interfaces between API-calling module 780 and implementation module 700. Transferring the API calls can include issuing, initiating, invoking, calling, receiving, returning, and/or responding to the function calls or messages. In other words, transferring can describe actions by either of API-calling module 780 or implementation module 700. In some embodiments, a function call or other invocation of API 790 sends and/or receives one or more parameters through a parameter list or other structure.

In some embodiments, implementation module 700 provides more than one API, each providing a different view of or with different aspects of functionality implemented by implementation module 700. For example, one API of implementation module 700 can provide a first set of functions and can be exposed to third party developers, and another API of implementation module 700 can be hidden (e.g., not exposed) and provide a subset of the first set of functions and also provide another set of functions, such as testing or debugging functions which are not in the first set of functions. In some embodiments, implementation module 700 calls one or more other components via an underlying API and thus be both an API calling module and an implementation module. It should be recognized that implementation module 700 can include additional functions, methods, classes, data structures, and/or other features that are not specified through API 790 and are not available to API calling module 780. It should also be recognized that API calling module 780 can be on the same system as implementation module 700 or can be located remotely and access implementation module 700 using API 790 over a network. In some embodiments, implementation module 700, API 790, and/or API-calling module 780 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, process 500 (FIG. 5) is performed at a first computer system (as described herein) via a system process (e.g., an operating system process, a server system process) that is different from one or more applications executing and/or installed on the first computer system.

In some embodiments, process 500 (FIG. 5) is performed at a first computer system (as described herein) by an application that is different from a system process. In some embodiments, the instructions of the application, when executed, control the first computer system to perform process 500 (FIG. 5) by calling an application programming interface (API) provided by the system process. In some embodiments, the application performs at least a portion of process 500 without calling the API.

In some embodiments, the application is an accessory companion application that is constructed for processing communication and management between the first computer system and an accessory device (e.g., a wearable device, such as, for example, a watch).

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform the method shown in FIG. 7 by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 790 defines a first API call that can be provided by API calling module 790. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 750) that runs the application. In some embodiments, the implementation module is included in an electronic device that is separate from the device that runs the application.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data.

Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes.

User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C#or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z).

Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

As described above, one aspect of the present technology is the gathering and use of data available from various sources to provide a comprehensive and complete window to a user's personal health record. The present disclosure contemplates that in some instances, this gathered data may include personally identifiable information (PII) data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, the personal information data can be used to provide enhancements to a user's personal health record. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A computer-implemented method comprising:
receiving, by a service provider from an application of a user device, a first request to generate a machine-readable optical image associated with a user account for use in transferring data to the user account, wherein:
the user account is associated with the user device; and
the first request includes account data associated with the user account;
transmitting, by the service provider to a server, a second request to validate the first request, wherein the second request includes the account data;
receiving, by the service provider from the server, a determination that the second request meets a threshold score based at least in part on the account data;
generating, by the service provider, the machine-readable optical image based at least in part on the determination;
transmitting, by the service provider to the application of the user device, the machine-readable optical image;
receiving, by the service provider from an issuing device, a notification of a data transfer to the user account;
generating, by the service provider, an updated data log for the user account based at least in part on the data transfer; and
disabling, by the service provider to the application of the user device, the machine-readable optical image based at least in part on the notification.

2. The computer-implemented method of claim 1, wherein the account data includes at least one of:
geolocation data including past and current geographic data of the user device; or
user information including at least one of security information or biometric information associated with the user account.

3. The computer-implemented method of claim 1, wherein the machine-readable optical image includes at least one of a barcode or a quick response code.

4. The computer-implemented method of claim 1, further comprising transmitting, by the service provider to an issuing device, an identifier request for a unique identifier associated with the machine-readable optical image based at least in part on the determination.

5. The computer-implemented method of claim 4, further comprising receiving, by the service provider from the issuing device, the unique identifier, wherein generating the machine-readable optical image is based at least in part on the unique identifier.

6. The computer-implemented method of claim 5, wherein receiving the unique identifier includes use conditions for the machine-readable optical image.

7. The computer-implemented method of claim 6, wherein the use conditions comprise at least one of an expiration time period, a numerical use limit, or sharing limitations.

8. The computer-implemented method of claim 1, further comprising generating, by the server, the determination by:
generating a validation score based at least in part on the account data; and
comparing the validation score to the threshold score.

9. The computer-implemented method of claim 8, generating the validation score is based at least in part on:
flagged user data of past suspicious behavior associated with the user account; or
historical image usage data including at least one of a frequency of previous optical images that were used over a time period or a timestamp of a most recent use of an optical image.

10. The computer-implemented method of claim 1, further comprising, prior to disabling the machine-readable optical image:
displaying, by the application, the machine-readable optical image;
scanning, by a third-party device, the machine-readable optical image; and
transmitting, by the third-party device to the issuing device, a data transfer request to update a stored data log of data in the user account, wherein the data transfer request includes information of data seeking to be transferred to the user account.

11. The computer-implemented method of claim 10, updating, by the issuing device, the stored data log to incorporate the information.

12. One or more non-transitory computer-readable media comprising computer-executable instructions that, when executed by one or more processors, cause the one or more processors to perform operations comprising:
receiving, by a service provider from an application of a user device, a first request to generate a machine-readable optical image associated with a user account for use in transferring data to the user account, wherein:
the user account is associated with the user device; and
the first request includes account data associated with the user account;
transmitting, by the service provider to a server, a second request to validate the first request, wherein the second request includes the account data;
receiving, by the service provider from the server, a determination that the second request meets a threshold score based at least in part on the account data;
generating, by the service provider, the machine-readable optical image based at least in part on the determination;
transmitting, by the service provider to the application of the user device, the machine-readable optical image;
receiving, by the service provider from an issuing device, a notification of a data transfer to the user account;
generating, by the service provider, an updated data log for the user account based at least in part on the data transfer; and
disabling, by the service provider to the application of the user device, the machine-readable optical image based at least in part on the notification.

13. The one or more non-transitory computer-readable media of claim 12, wherein the account data includes at least one of:
geolocation data including past and current geographic data of the user device; or
user information including at least one of security information or biometric information associated with the user account.

14. The one or more non-transitory computer-readable media of claim 12, wherein the machine-readable optical image includes at least one of a barcode or a quick response code.

15. The one or more non-transitory computer-readable media of claim 12, further comprising transmitting, by the service provider to an issuing device, an identifier request for a unique identifier associated with the machine-readable optical image based at least in part on the determination.

16. The one or more non-transitory computer-readable media of claim 15, further comprising receiving, by the service provider from the issuing device, the unique identifier, wherein generating the machine-readable optical image is based at least in part on the unique identifier.

17. The one or more non-transitory computer-readable media of claim 16, wherein receiving the unique identifier includes use conditions for the machine-readable optical image.

18. The one or more non-transitory computer-readable media of claim 17, wherein the use conditions comprise at least one of an expiration time period, a numerical use limit, or sharing limitations.

19. A system comprising:
a memory comprising computer-executable instructions; and
a processor configured to access the memory and execute the computer-executable instructions to at least:
receive, by a service provider from an application of a user device, a first request to generate a machine-readable optical image associated with a user account for use in transferring data to the user account, wherein:
the user account is associated with the user device; and
the first request includes account data associated with the user account;
transmit, by the service provider to a server, a second request to validate the first request, wherein the second request includes the account data;
receive, by the service provider from the server, a determination that the second request meets a threshold score based at least in part on the account data;
generate, by the service provider, the machine-readable optical image based at least in part on the determination;
transmit, by the service provider to the application of the user device, the machine-readable optical image;
receive, by the service provider from an issuing device, a notification of a data transfer to the user account;
generate, by the service provider, an updated data log for the user account based at least in part on the data transfer; and
disable, by the service provider to the application of the user device, the machine-readable optical image based at least in part on the notification.

20. The system of claim 19, further comprising:
transmitting, by the service provider to an issuing device, an identifier request for a unique identifier associated with the machine-readable optical image based at least in part on the determination; and
receiving, by the service provider from the issuing device, the unique identifier and use conditions associated with the unique identifier, wherein generating the machine-readable optical image is based at least in part on the unique identifier.
